(19) United States
(12) Patent Application Publication
(10) Pub. No.: US 2013/0181015 A1
(43) Pub. Date: Jul. 18, 2013

(54) Aerobottle Plus Mount Apparatus and Related Methods of Use

(71) Applicant: William Cason, Coral Gables, FL (US)

(72) Inventor: William Cason, Coral Gables, FL (US)

(21) Appl. No.: 13/553,754

(22) Filed: Jul. 19, 2012

Related U.S. Application Data
(60) Provisional application No. 61/509,225, filed on Jul. 19, 2011.

(51) Int. Cl. B60P 3/22; B62J 11/00

(52) U.S. Cl. CPC B62J 11/00
USPC 222/608; 215/316; 215/329; 224/414; 222/78

(57) ABSTRACT

Disclosed is a water bottle plus related mounting apparatus and methods.

### CROSS-REFERENCE TO RELATED APPLICATIONS

This application claims the priority of U.S. Provisional Patent Application Ser. No. 61/509,225 (filed Jul. 19, 2011) entitled “Aerobottle plus mount apparatus and related methods of use.” Said provisional application is incorporated by reference in its entirety.

### STATEMENT REGARDING FEDERALLY SPONSORED RESEARCH OR DEVELOPMENT

Not Applicable.

### BACKGROUND OF THE INVENTION

1. Field of Invention

This application is in field of the water bottles for use in connection with bicycle-riding.

2. Background

Competitive bicycle (or bike) riding (also known as cycling) and triathlons are well known activities. Frequently, triathletes or cyclists become thirsty or dehydrated over the course of a ride or bike portion of a triathlon, but nevertheless continue the ride without a break so that a competative advantage is not lost. To provide such thirsty or dehydrated riders with a drink, water bottles (for water or other drinkable fluids) have been developed that are mountable to the frame or handlebars of a bike.

A common type of water bottle, exemplified by U.S. Pat. No. 5,326,006 (issued Jul. 5, 1994), is removably attachable to a bike frame via a mount so that the rider may: (1) retrieve the water bottle; (2) bring the spout of the bottle to his or her mouth; (3) drink; and (4) return the bottle. See also U.S. Pub. Pat. App. No. 2004/0256428 (published Dec. 23, 2004). Although such a water bottle is suitable for leisurely bike riding, the same is not entirely suitable for bike racing since the actions necessary to accomplish a drink: (a) require extra effort and energy that may otherwise have been applied to spinning the bike wheels; and (b) cause the rider to momentarily break from hunched aerodynamic position over the bike handle bars. Thus, bottles have been developed to reduce the amount of actions and position changes required by a bike rider for thirst quench or hydration.

A known way to reduce the amount of actions and position changes required by a cyclist for thirst quench or hydration is to provide a straw from the water bottle to the cyclist's mouth. Although an improvement over the remove-plus-reattach type water bottles discussed above, providing a long straw from the bottle to the cyclist's mouth, like U.S. Pat. No. 6,913,135 (issued Oct. 11, 2005) and U.S. Pub. Pat. App. No. 2011/0011908 (published Jan. 20, 2011) (2011/0011908, FIG. 1), is still unsatisfactory since: (1) longer straws are difficult to clean and frequently become unsanitary; (2) longer straws cause a significant amount of wind resistance/drag; and (3) the end of a longer straw is difficult to comfortably place at the mouths of riders, particularly since different body types may necessitate excessive to achieve hydration.

Such unsatisfactory aspects of known water bottles are somewhat alleviated by positioning the water bottle closer to the mouth of the cyclist, but still unsatisfactory aspects are present. For example, U.S. Pat. Nos. 5,497,920 (issued Mar. 12, 1996) and 5,803,328 (issued Sep. 8, 1996) position water bottles between the handle bars of a bike so that a spout or straw is proximate to the cyclist's mouth, but: (a) the water bottles are vertically positioned and, as a result, produce undesirable wind drag; and (b) the water bottles' mounting apparatus still do not accommodate customized straw-end to cyclist-mouth positioning.

Attempts have been made to resolve the identified aerodynamic flaws of water bottles designed for positioning in close proximity to the cyclist's mouth, but such attempts have heretofore also been unsatisfactory overall. For instance, U.S. Pat. App. Ser. No. 2007/0612740 (published Jan. 18, 2007) discloses water bottles that are more aerodynamically favorable than other known bottles, but the bottles disclosed in that published application are nevertheless unsatisfactory because, being vertically positioned, said bottles still have a large wind drag cross-section. See “Aerobar Drink Systems Review” by trisports.com for a discussion and performance comparisons of various water bottles. Although an aerodynamic improvement over U.S. Pub. Pat. App. No. 2007/0612740, U.S Pub. Pat. App. No. 2010/0257973 (published Oct. 14, 2010) is permanently installed on the bike so that cleaning of the bottle is difficult and the straw end positioning cannot easily be customized to riders of differing physical size. U.S. Pub. Pat. App. No. 2011/0011908 (published Jan. 20, 2011) (2011/0011908, FIG. 11) discloses positioning an ordinary water bottle horizontally between the aerobars of a bike with a vertical straw adaptor so that the wind drag cross section is reduced over a vertical bottle alignment, but (a) the flat butt of the bottle is positioned in the direction of the bike, and (b) a bulky mounting system is employed so that the design is not adequately aerodynamic. The water bottle and mounting system disclosed in U.S. Pub. Pat. App. Ser. No. 2010/0059565 reduces the vertical wind-drag cross section as compared with U.S. Pub. Pat. App. Nos. 2007/0612740 and 2010/0257973, but the bottle is positioned further away from the mouth of the cyclist so that a longer straw is required (leading to the unsatisfactory aspects identified above), and the bottle may be permanently attached to the bike frame so that straw placement is not customizable and rendering cleaning of the bottle difficult. Accordingly, a need exists for a water bottle and related mounting apparatus that are aerodynamic, adjustable, customizable to riders, and sanitary.

In addition, bike races are of sufficient duration that the fluid capacity of a single bottle is insufficient for hydrating the racing cyclist. In such circumstances it is desirable for a water bottle that is either replaceable or refillable while riding. Replaceable water bottles, such as U.S. Pat. No. 5,326,006 and U.S. Pub. Pat. App. No. 2004/0256428, may be unsatisfactory if no extra bottles are around. Refillable water bottles, such as U.S. Pat. No. 5,497,920 and U.S. Pub. Pat. App. No. 2011/0011908, are unsatisfactory since: (i) a sponge over the refill port can become either unsanitary or lost (e.g., a bump may discharge the sponge from its position over the water); and (ii) sliced lid refill ports are not water-tight (i.e., permit water to splash out) and require either (aa) insertion of a refill source through the sliced lid and (bb) complicated splash resistant devices (e.g., a one directional funnel). Accordingly, a need exists for exchangeable or refillable bike-mounted water bottles that do not feature the unsatisfactory aspects of known water bottles.

### SUMMARY OF THE INVENTION

In view of the foregoing, it is an object of this application to disclose water bottles and related mounting apparatus that are aerodynamic, customizable to riders, sanitary, and easily refillable or exchangeable. It is a further objective of this application to disclose water bottles and related mounting apparatus that do not feature the unsatisfactory aspects of the water bottles identified above. As a preferable means for meeting the above-recited objectives, this application discloses: (1) a water bottle that may be (a) aerodynamically shaped with a small wind drag when mounted on a bike, (b) easy to clean, and (c) easy to refill or exchange; and (2) a mounting system for said water bottle that (i) may be used to adjust the position of the water bottle relative to a cyclist's mouth, (ii) is easy to install, (iii) permits easy removal and installation of said water bottle, and (iv) supports a bicycle computer. The disclosed water bottle may feature: a cylindrical water receptacle body with a butt at one end and removable bullet shaped nose at the other; a straw extending radially from said body adjacent said butt; and a radial re-fill port in the midsection of the body. The disclosed mounting system may also feature: aerobar fasteners coupled to a platform, wherein the platform is configured to be positioned between aerobars of a bike; and, a cage for retention of a water bottle and bicycle computer, said cage affixed to, and selectively positionable along, said platform.

### BRIEF DESCRIPTION OF THE FIGURES

The manner in which these objectives and other desirable characteristics can be obtained is better explained in the following description and attached figures in which:

FIG. 1 is an environmental view of a water bottle 100 and related mounting apparatus 200.

FIG. 2 is a perspective view of the water bottle 100 depicted in FIG. 1

FIG. 3 is a front view of the water bottle 100 depicted in FIG. 1.

FIG. 4 is a back view of the water bottle 100 depicted in FIG. 1.

FIG. 5 is a right side view of the water bottle 100 depicted in FIG. 1.

FIG. 6 is a left side view of the water bottle 100 depicted in FIG. 1.

FIG. 7 is a top view of the water bottle 100 depicted in FIG. 1.

FIG. 8 is bottom view of the water bottle 100 depicted in FIG. 1.

FIG. 9 is a front view of the mounting apparatus 200 depicted in FIG. 1.

FIG. 10 is a right side view of the mounting apparatus 200 depicted in FIG. 1.

FIG. 11 is a back view of the mounting apparatus 200 depicted in FIG. 1

FIG. 12 is a left side view of the mounting apparatus 200 depicted in FIG. 1.

FIG. 13 is a top view of the mounting apparatus 200 depicted in FIG. 1.

FIG. 14 is bottom view of the mounting apparatus 200 depicted in FIG. 1.

FIGS. 15 through 23 illustrate various views of an alternated embodiment of the bottle and mounting apparatus disclosed by this specification.

FIGS. 24 through 32 illustrate various exploded views of the alternate embodiment depicted in FIGS. 15 through 23.

It is to be noted, however, that the appended figures illustrate only a typical embodiment disclosed in this application, and therefore, are not to be considered limiting of the scope of invention principles, for the invention principles disclosed herein may admit to other equally effective embodiments that will be appreciated by those reasonably skilled in the relevant arts. For instance, the components in the figures are not necessarily to scale, with an emphasis instead being placed upon illustrating the principles of the invention. In the figures, like reference numerals designate corresponding parts throughout the different views.

### DETAILED DESCRIPTION OF PREFERRED EMBODIMENTS

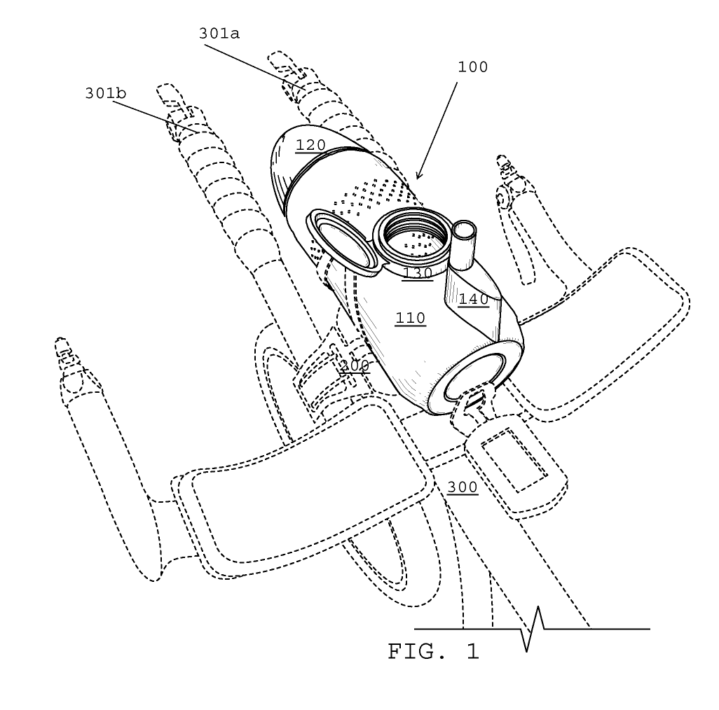

FIG. 1 depicts a preferable embodiment of a water bottle 100 that is preferably (a) aerodynamically shaped with a small wind drag cross-section when mounted on a bike 300, (b) easy to clean, and (c) easy to refill or exchange; and a mounting apparatus 200 for said water bottle 100 that (i) may be used to adjust the position of the water bottle 100 relative to a cyclist's mouth, (ii) is easy to install, (iii) permits easy removal and installation of said water bottle 100, and (iv) supports a bicycle computer. As seen in the figure, the water bottle 100 may be generally cylindrical and the mounting apparatus 200 may be removably installed and positioned between two aerobars 301a and 301b as shown. More specific aspects of the water bottle and related mounting system are disclosed with reference to the subsequent figures.

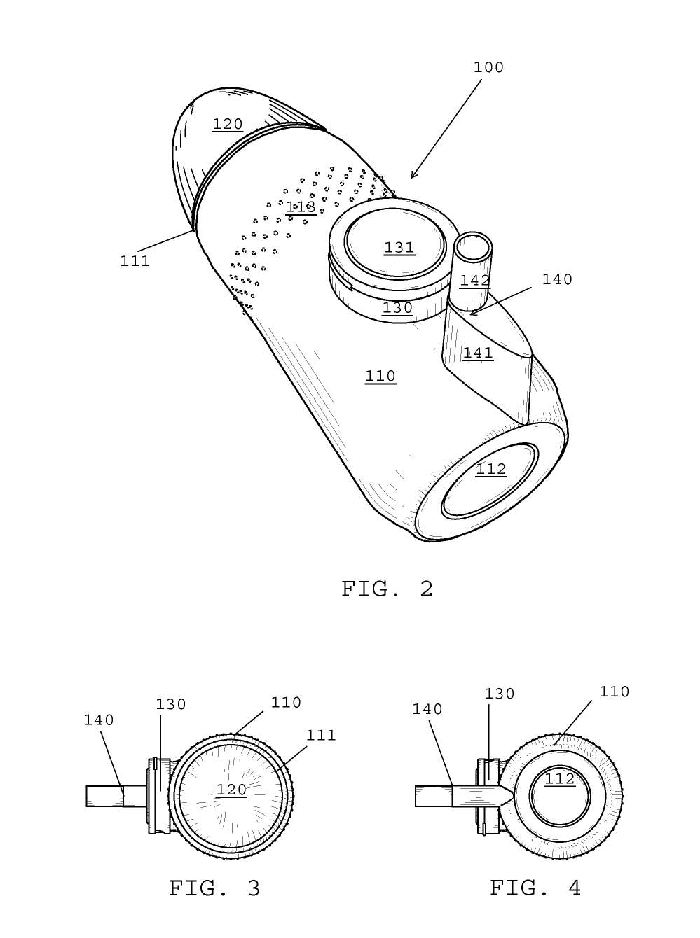

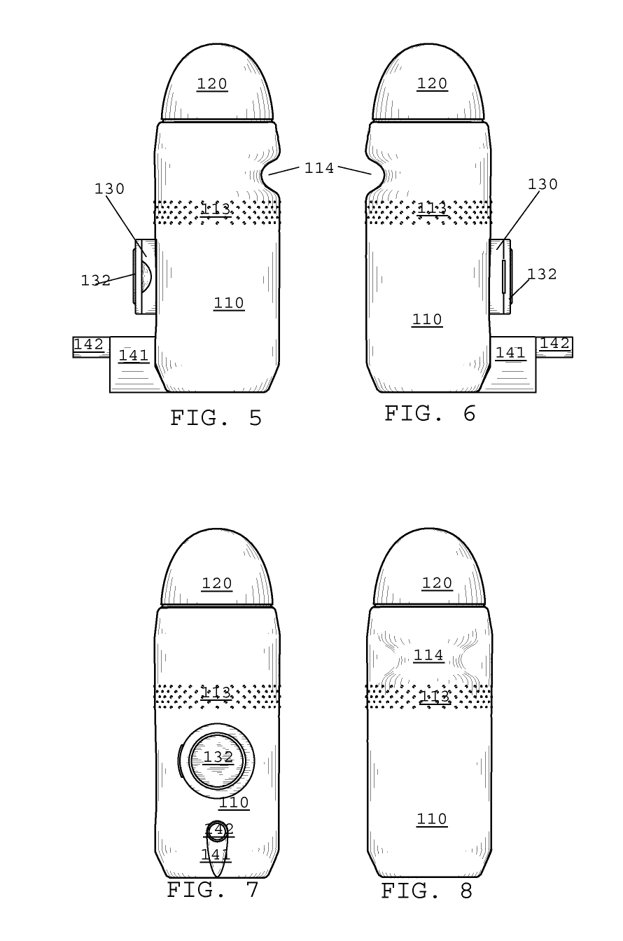

FIGS. 1 through 8 illustrate the preferable features of the bottle 100. The referenced figures respectively depict an environmental view (FIG. 1), a perspective view (FIG. 2), a front view (FIG. 3), a back view (FIG. 4), a right side view (FIG. 5), a left side view (FIG. 6), a top view (FIG. 7), and bottom view (FIG. 8) of the water bottle 100 depicted in FIG. 1. As seen in the figures, the depicted bottle 100 basically features: a body 110, a nose 120, a refill port 130, and a straw 140.

FIGS. 2 through 8 best depict the body 110. Referring to those figures, the body 110 may be generally cylindrical and feature an open end 111 (not shown as the opening is covered by the nose 120 in the manner of a screw cap or lid), a butt end 112, gripping protuberances 113 around a midsection, and a socket 114 for interaction with a mounting cage on an underside. As further seen in the figures, the body 100, although generally cylindrical, may preferably taper from smaller to larger diameter from the opening 111 to the butt 112 for aerodynamics. The body 110 is preferably configured to retain water (or any other fluid) deposited therein in the usual manner of known water bottles. Preferably, the body 110 may be formed of light weight materials suitable for water retention and such materials and manners of formation will be well known to those of skill in the art. In a preferable embodiment the body 110 is formed of plastic (e.g., polyethylene, polypropylene) by molding.

The nose 120 is depicted in FIGS. 2 through 8. As seen in those figures, the nose 120 generally defines a cap for placement over the opening 111 of the body 110. The geometry of the nose 120 is preferably pointed or bullet-like. Operably, the nose may be electively removed or installed over the opening 111 of the body 110 in any manner known in the art of water bottle lids. Such methods may include male-to-female screw threads, snap or click interaction, and the like. Preferably, the nose 120 may be formed of light weight materials suitable for water retention and such materials and manners of formation will be well known to those of skill in the art. In a preferable embodiment: (1) the nose 120 is formed of plastic (e.g., polyethylene) by molding; and, (2) the nose 120 may be coupled to the body via male-to-female screw threads (with the male threads on the open end 111 of the body 110 or the male threads on the nose 120).

The refill port 130 is best depicted in FIGS. 1 through 7. The refill port 130 is generally defined by a hinged cap 131 and a hole 132 (see FIG. 1) through a top wall of the body 110. The cap 131 may suitably hinge in any direction or orientation relative to the hole 132, but on a preferred embodiment, the cap 131 preferably hinges from right to left. The cap 131 may preferably be of plastic or other suitable materials. The cap 131 may be formed by molding or any other method otherwise known to those of skill in the art. The hole 132 may be formed in the body 110 by molding or cutout and the hinged cap 131 may preferably be placed thereover in the known manner for placing a cap over an opening. Such manners include male-to-female screw threads, snap or click interaction, and the like.

The straw 140 is depicted in FIGS. 2 through 7. As seen in the figure the straw comprises a tube 142 and an aerodynamic sleeve 141. As best seen in FIG. 5, the tube 142 preferably extends into the body 110 and the sleeve 141 covers at least a portion of the tube 142 that is external to the body 110. The tube 142 may be any straw-like tube known to those of skill in the art. As best seen in FIG. 7, the sleeve may preferably be tear drop in cross section. The sleeve 141 is optional and may be a separate component of the bottle 100 or formed with the body 110. Preferably the sleeve is formed or molded of light weight materials including plastics and foamed plastics.

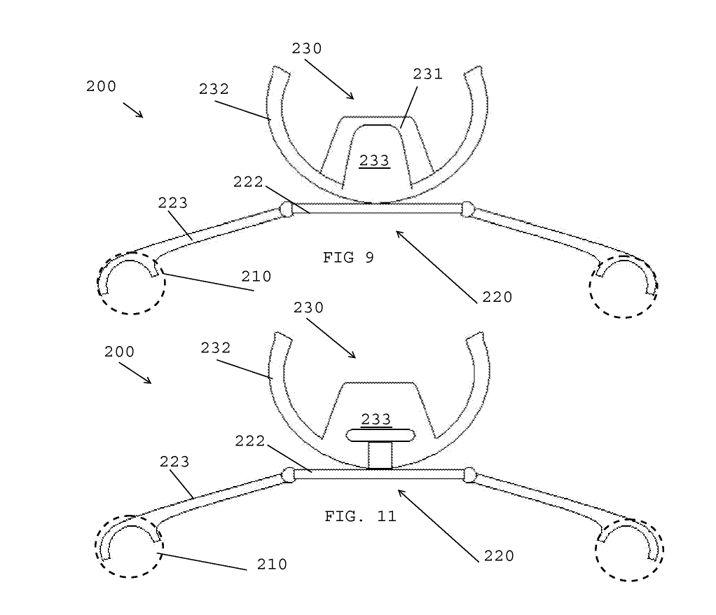

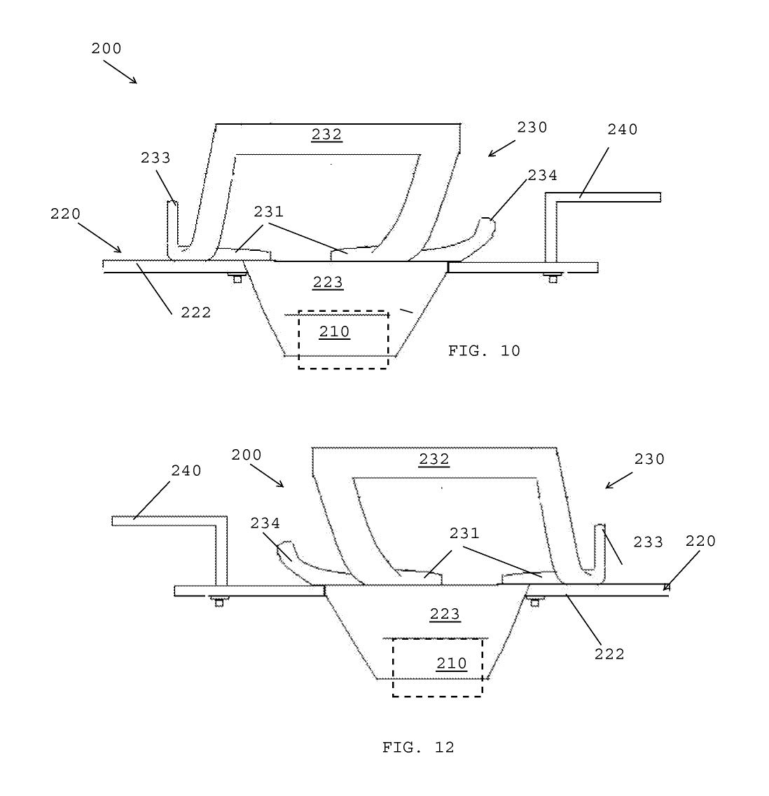

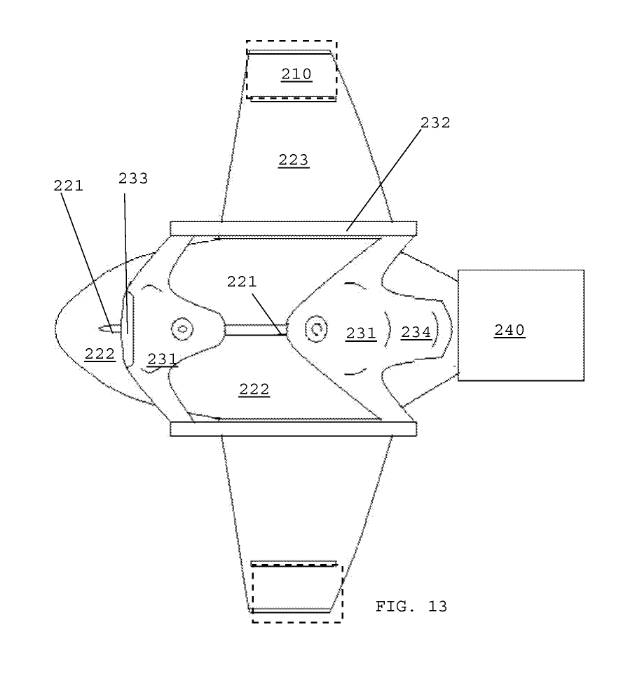

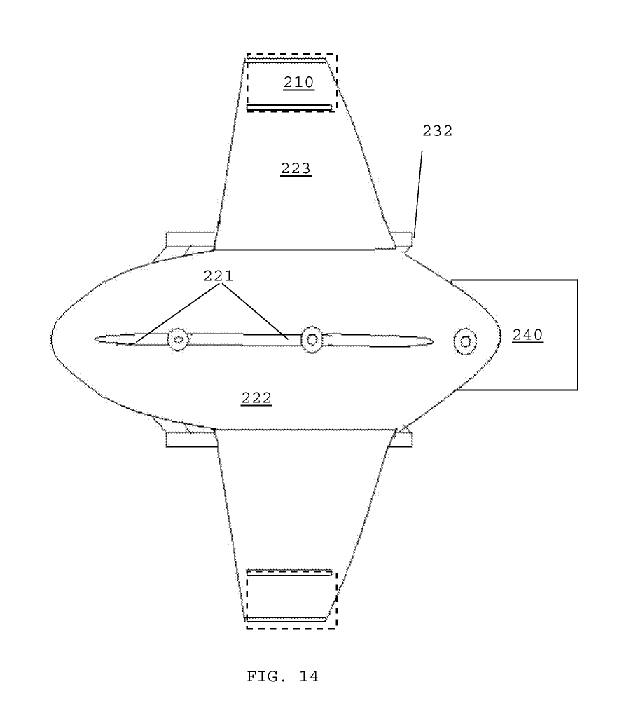

FIGS. 1 and 9 through 14 illustrate the preferable features of the mounting apparatus 200. The referenced figures respectively depict a front view, a right side view, a back view, a left side view, a top view, and bottom view of the mounting apparatus 200 depicted in FIG. 1. As seen in said figures, the depicted mounting apparatus 200 basically features: at least one aerobar fastener 210, a platform 220, a water bottle cage 230, and a small platform 240 attached to the back of the apparatus for supporting a bicycle computer.

The aerobar fastener 210 and platform 220 are best depicted in FIGS. 1 and 9 through 14. The platform 220 is a support surface 221 with at least one slit 222, and optional arms 223 extending from the support surface toward the fasteners 210. The aero bar fastener 210 (depicted as broken lines) may be a means for securing the platform 220 to the aerobars 301a and 301b of a bike 300. The fasteners may preferably be any known method of cinching including, but not limited to, zip ties or straps with hooks and loop locking mechanisms (e.g., Velcro® straps). The support surface 221 may be formed or molded of light weight materials, including carbon fibers or plastics. Suitably the platform may be formed with or connected to arms 223 extending from the support surface 221 to the fasteners 210. The support surface 221 and arms 223 may be formed as a single unit or as separate units that are assembled together. In the depicted embodiment, the arms are separate from the support surface 221 and hingedly connected thereto so that the mounting apparatus 200 may be adapted to fit bikes with aerobars separated by differing distances (e.g., the arms may be hinged together for closely spaced aerobars or hinged apart for aerobars spaced by larger distances). Suitable materials and formation methods for the arms 223 will be well known to those of skill in the art. In a preferable embodiment the arms are molded plastic. In an alternative embodiment, support surface 221 is secured to the aerobars directly via the fasteners 210 (e.g., via zip cords or Velcro® straps).

The cage 230 is best depicted by FIGS. 1 and 9 through 14. As seen in the figures, the cage 230 is defined by a base 231, a frame 232, a plug 233, and a back 235. The base 231 is at the bottom of the cage 230 and configured to interface with the top of the support surface 221 of the platform 220. The frame 232 extends from either side of the base and curves upward. The frame 232 is preferably configured for front or back receipt of a water bottle 100 (it should be noted that top-down insertion, in the manner of U.S. Pat. No. 609,690 (issued Aug. 23, 1998), may also be operable). The plug 233 extends upwardly and forwardly of the front of the base 231 while the back 234 extends upwardly of the back of the base 231 whereby (1) the plug 233 is configured to insert into the socket 114 of an installed water bottle 100 and (2) the back 234 is configured to abut the butt 111 of an installed water bottle as shown in FIG. 1. Operably, the plug 233 and back 234 assure that an installed water bottle 300 may not move forward or backward relative to the cage 300 or so that the bottle will not twist left or right within the cage 300. The cage 300 may be preferably formed or molded (e.g., molded, pressed, extruded or cut) of lightweight materials, including plastics or aluminum. The cage 300 and platform 220 may preferably be affixed via screw and nut (or the like) through the slits 221 in the platform. In operation, the position of the cage 300 may be shifted forward or aft relative to the platform via loosening of the screw and nut and moving the screw along the slits 221. After installation of the mounting apparatus 200 between aerobars 301a and 301b, the cage 300 position along the platform 220 may be manipulated via tightening or loosening the screw/nut so that the cage may move forward or aft along the slits 221.

FIG. 1 illustrates a preferable operation of the disclosed water bottle 100 and mounting apparatus 200. The mount apparatus 200 may be fixedly located between the aerobars 301a and 301b of the bicycle 300 via securing the aerobar fasteners around the aerobars 301a and 301b. The water bottle 100 may be placed in the cage 230 so that the nose 120 is facing in the direction of the bicycle 300, the plug 233 is inserted into the socket 114, and the butt 111 is against the back 223. The cage 300 may be adjusted along the slits 221 for customized placement of the straw 140 relative to a cyclist's mouth. During operation of the bicycle 300, an empty water bottle 100 may be either (1) exchanged or (2) refilled via the water port 130 (i.e., by opening the cap 131 and pouring water into the body 110 of the water bottle 100). After use, the water bottle 100 may be removed from the bicycle without disturbing the installation or configuration of the mounting apparatus 200 so that the bottle 100 may be cleaned (for easier cleaning, the nose 120 may be removed for better access to the inside of the housing 110).

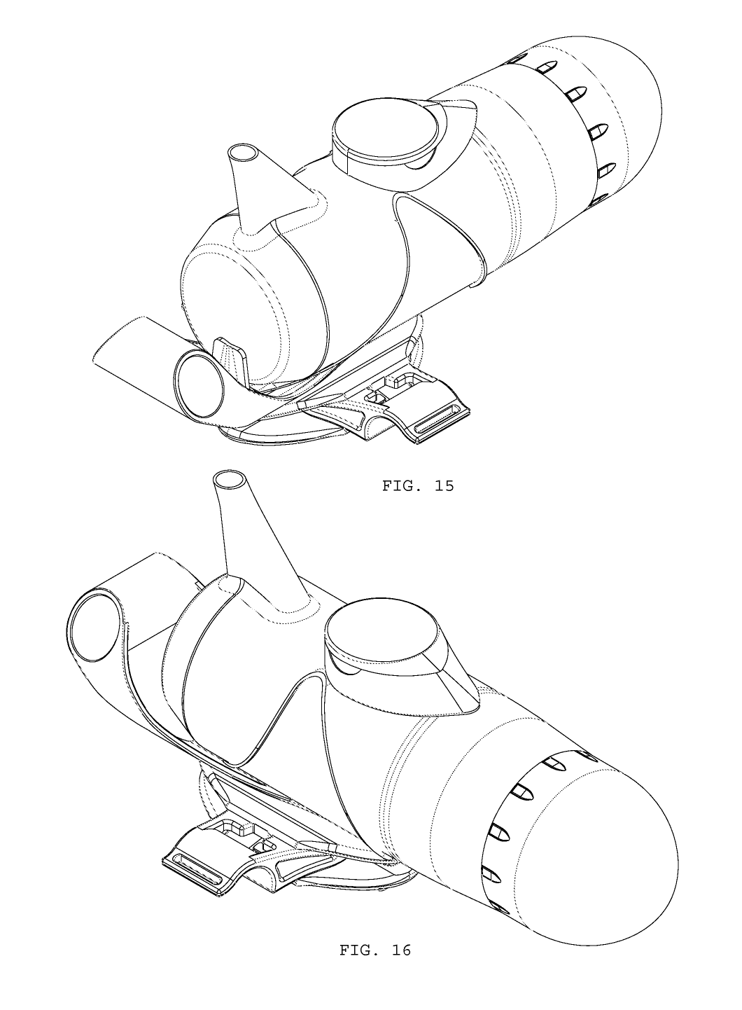

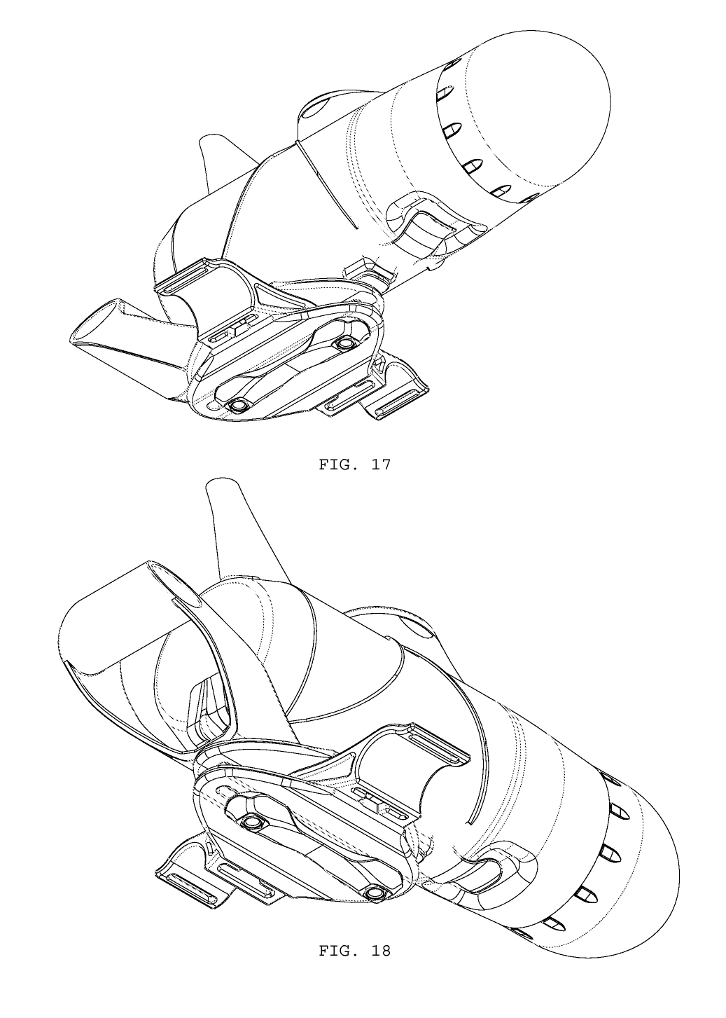

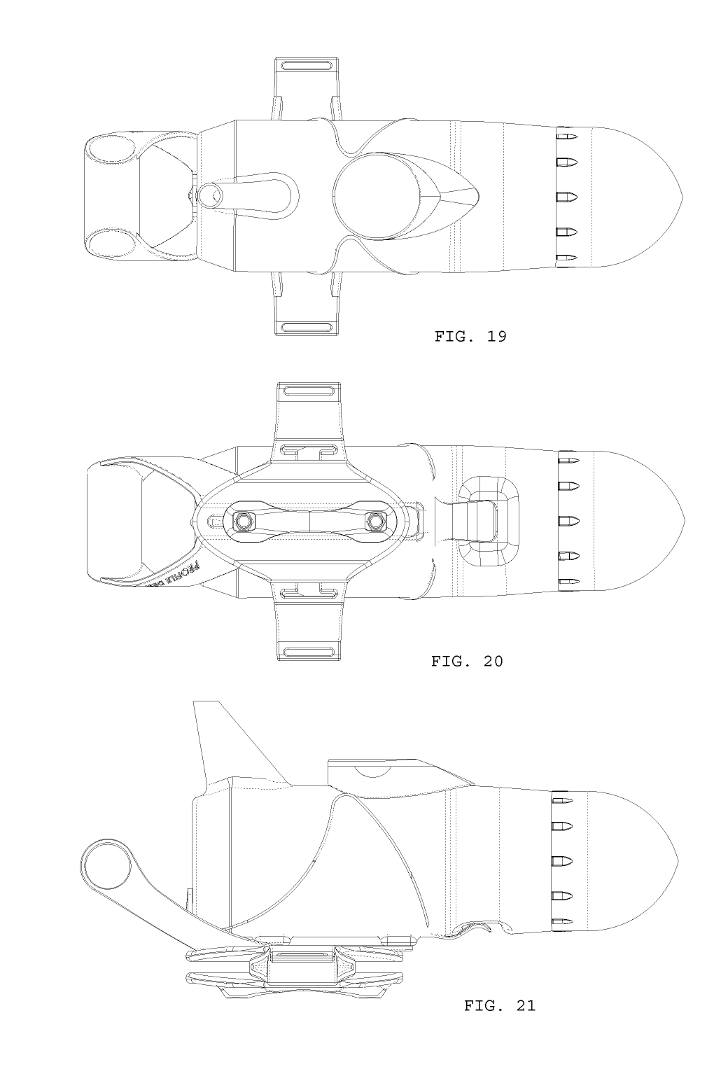

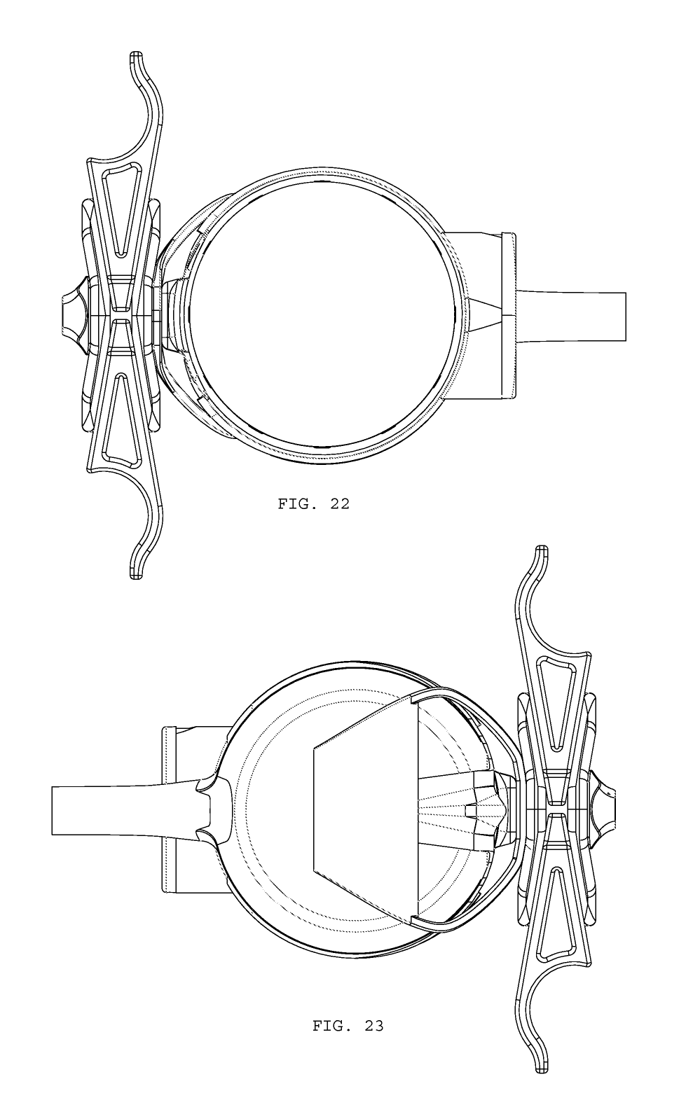

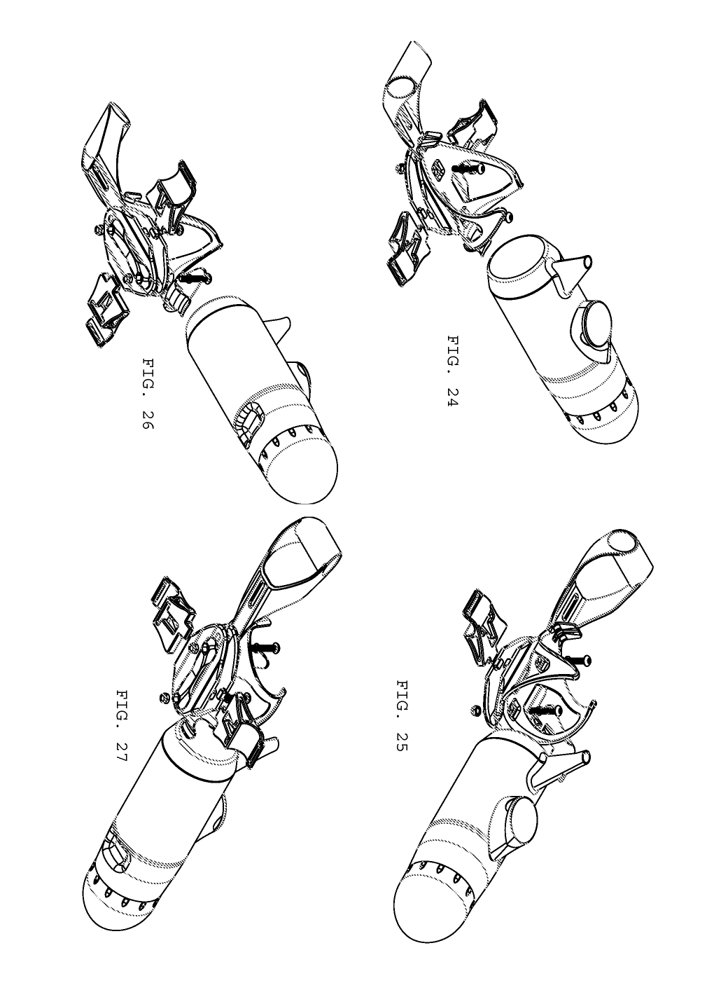

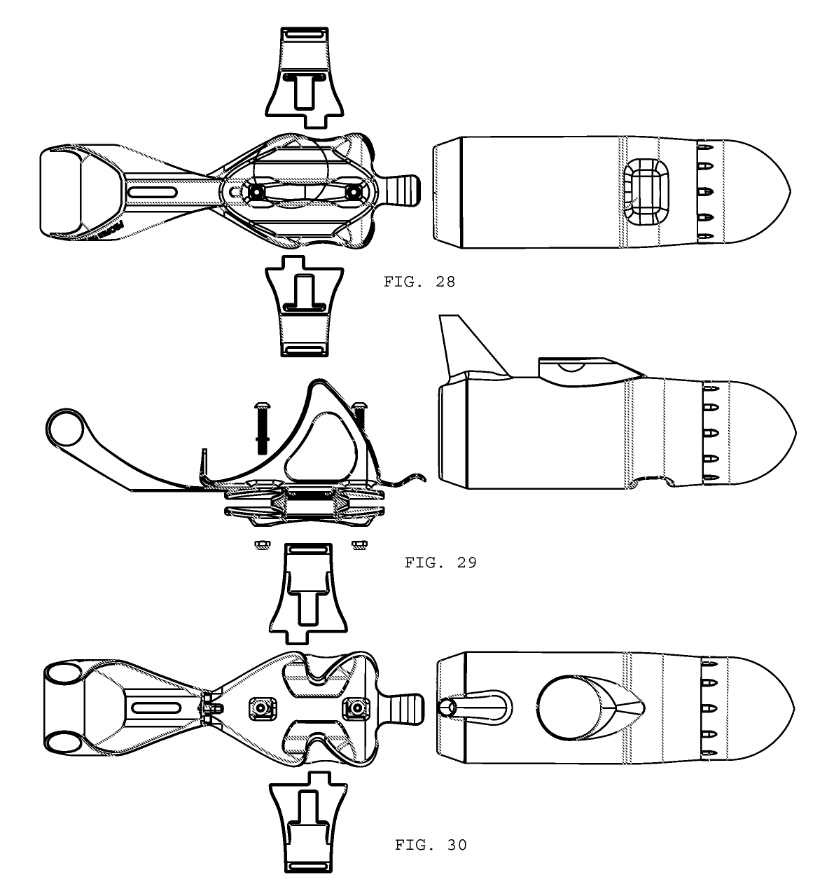

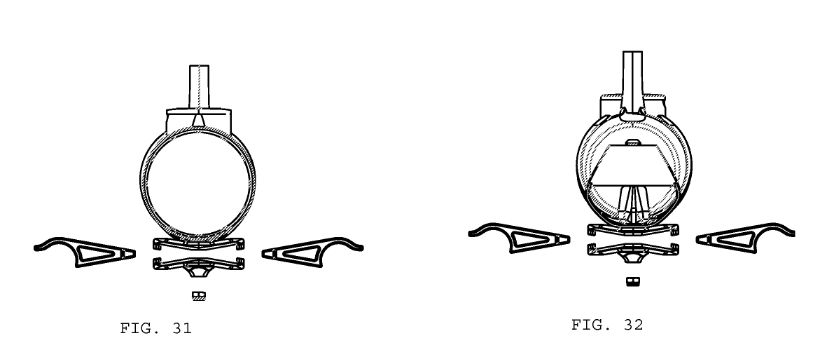

The foregoing description of implementations has been presented for purposes of illustration and description. It is not exhaustive and does not limit the claimed inventions to the precise form disclosed. Modifications and variations are possible in light of the above description or may be acquired from practicing the invention. For instances, a bottle and mounting apparatus of FIGS. 15 through 32 illustrate another embodiment of the invention that does not depart from the spirit and intent of the invention. The claims and their equivalents define the scope of the invention. These aspects, among other things, demonstrate the industrial applicability of this invention.

Moreover, it should be apparent that further numerous structural modifications and adaptations may be resorted to without departing from the scope and fair meaning of the present invention as set forth hereinabove and as described herein below by the claims.

What is disclosed may be an bottle with a pointed nose, a hinged-capped re-fill port, and sleeved straw. What is also disclosed may be a mounting apparatus with a cage, a platform, and aerobar fasteners. Yet still, what is disclosed may be a method of hydrating comprising the steps of: (1) riding a bicycle; (2) accepting a fluid dispenser while performing the step of riding a bicycle; (3) hinging open the cap of a re-fill port of an aerodynamic water bottle while still performing the step of riding a bicycle; (4) dispensing fluid via the fluid dispenser into the re-fill port while still performing the step of riding a bicycle; and (5) hinging closed the cap of the re-fill port. Yet still what is disclosed may be a method of providing water to a cyclist comprising the step of: (1) installing a mounting apparatus with a cage affixed to a platform between the aerobars of a bicycle; (2) placing a water bottle with a refill port and straw adjacent its butt in the cage of the mounting apparatus; (3) moving the cage and water bottle relative to the platform; and directing the cyclist to drink from the straw.

I claim:

1. A bottle comprising:
a body capable of retaining fluid;
a pointed nose cap that is selectively closable over an open end of the body;
a re-fill port through the side of the body; and,
an straw extending from and through the side of the body.

2. The bottle of claim 1 wherein the pointed nose is a cap for the bottle.

3. The bottle of claim 2 wherein the geometry of the nose is bullet-like.

4. The bottle of claim 3 wherein the nose and open end of the body are configured for elective removal or installation of the nose over the opening of the body.

5. The bottle of claim 4 wherein the configuration of the nose and open end of the body is selected from the group consisting essentially of male-to-female screw threads.

6. The bottle of claim 1 wherein the re-fill port is defined by a hinged cap and a hole through the side of the body, wherein the cap may be hinged over the hole to close the hole.

7. The bottle of claim 6 wherein the hinged cap hinges from right to left.

8. The bottle of claim 1 wherein the straw is rendered aerodynamic via a sleeve with a tear-drop cross section.

9. The bottle of claim 8 wherein the sleeve is formed with the body.

10. The bottle of claim 1 wherein the straw is formed with the body.

11. The bottle of claim 1 installed in a mounting apparatus comprising:
a cage;
a platform; and,
at least one aerobar fastener.

12. The bottle of claim 11 wherein the platform is a support surface with (a) at least one slit and (b) two arms, each extending in opposite lateral directions from the support surface, each having one of said at least one aerobar fasteners.

13. The bottle of claim 12 wherein the cage is defined by a base, a frame, a plug, and a back.

14. The bottle of claim 13 wherein:
the base is at a bottom portion of the cage and configured to interface with the top of the support surface of the platform;
the frame extends from either side of the base and curves upward so that the frame is configured for front or back receipt of the water bottle

15. The bottle of claim 14 wherein the cage and platform are affixed via screw and nut through the slits in the platform so that, in operation, the position of the cage may be shifted forward or aft relative to the platform via loosening of the screw and nut and moving the screw along the slit.

16. A method of hydrating comprising the steps of:
(1) riding a bycicle;
(2) accepting a fluid dispenser while performing the step of riding a bicycle;
(3) hinging open the cap of a re-fill port of an aerodynamic water bottle while still performing the step of riding a bicycle;
(4) dispensing fluid via the fluid dispenser into the re-fill port while still performing the step of riding a bicycle; and
(5) hinging closed the cap of the re-fill port.

17. A method of providing fluid for hydration to a cyclist comprising the step of:
(1) installing a mounting apparatus with a cage affixed to a platform between the aerobars of a bicycle;
(2) placing a water bottle in the cage of the mounting apparatus, said wotter bottle with a refill port and straw adjacent to a butt of the water bottle;
(3) moving the cage and water bottle relative to the platform; and
(4) directing the cyclist to drink from the straw.

18. The method of claim 17 wherein the platform is a support surface with (a) at least one slit and (b) two arms, each extending in opposite lateral directions from the support surface, each having one of said at least one aerobar fasteners.

19. The method of claim 18 wherein the cage is defined by a base, a frame, a plug, and a back.

20. The method of claim 19 wherein:
the base is at a bottom portion of the cage and configured to interface with the top of the support surface of the platform;
the frame extends from either side of the base and curves upward so that the frame is configured for front or back receipt of the water bottle
